(19) United States
(12) Patent Application Publication
(10) Pub. No.: US 2011/0052885 A1
(43) Pub. Date: Mar. 3, 2011

(54) WATER SOLUBLE AZO COMPOUND OR SALT THEREOF, INK COMPOSITION AND COLORED BODY

(75) Inventors: Ryoutarou Morita, Tokyo (JP); Akira Kawaguchi, Tokyo (JP); Yoshiaki Kawaida, Tokyo (JP)

(73) Assignee: NIPPON KAYAKU KABUSHIKI KAISHA, Tokyo (JP)

(21) Appl. No.: 12/863,153

(22) PCT Filed: Jan. 13, 2009
(86) PCT No.: PCT/JP2009/050307

§ 371 Date: Jul. 15, 2010

(30) Foreign Application Priority Data
Jan. 25, 2008 (JP) 2008-014926

(51) Int. Cl. B32B 3/10; C09B 31/14; C09D 11/02; B41J 2/175

(52) U.S. Cl. 428/195.1; 534/797; 106/31.13; 347/86; 347/100; 347/20

(57) ABSTRACT

Provided is a water soluble azo compound represented by the following formula (1) or a salt thereof, which serves as a yellow coloring matter having a hue with high brilliance which is suitable for ink jet recording, and which enables a recorded matter to have various superior fastness properties. When an ink composition is prepared using the azo compound or a salt thereof, the ink composition can have superior storage stability. Also provided is an ink composition containing the water soluble azo compound or a salt thereof.

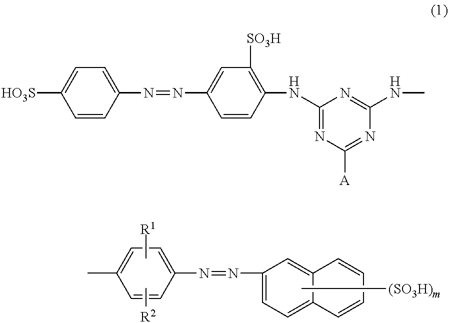

In the formula (1), R¹ and R² each independently represent a hydrogen atom, an alkyl group having 1 to 4 carbon atoms, or an alkoxy group having 1 to 4 carbon atoms; m represents an integer of 1 to 3; and A represents an amine residue represented by any one of the following formulae (2) to (5).

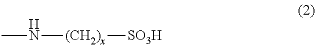

In the formula (2), x represents an integer of 1 to 3.

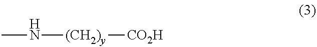

In the formula (3), y represents an integer of 1 to 11.

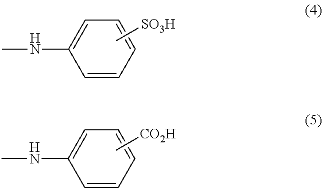

### TECHNICAL FIELD

The present invention relates to a water soluble azo compound or a salt thereof, an ink composition containing the same, and a colored body colored therewith.

### BACKGROUND ART

For a recording method by an ink jet printer, which is one typical method among a variety of color recording methods, a variety of ink discharge systems have been developed; however, such systems execute recording by generating ink droplets, which are attached to any of a variety of record-receiving materials (e.g., paper, film, and fabric, etc.). According to this method, a recording head is not brought into direct contact with the record-receiving material; therefore, generation of noise can be avoided thus achieving silent recording. In addition, due to having the feature of reduced size, increased speed and coloring can be readily achieved, and prevalence in recent years has been in rapid progress, and great advancement hereafter is expected.

Inks containing a water soluble dye dissolved in an aqueous medium have been used as conventional inks for fountain pens, felt pens etc., and inks for ink jet recording. Furthermore, to these inks is generally added a water soluble organic solvent in order to prevent pen tips or ink discharge nozzles from clogging with the ink. For these inks, demanded are abilities to generate a recorded image with satisfactory density, probability of avoiding occurrence of clogging at the pen tips and nozzles, favorable drying characteristics on the record-receiving materials, suppression of bleeding, superior storage stability, and the like. Additionally, fastness such as water resistance, moisture resistance, light resistance and gas resistance has been required of the recorded image.

Clogging of nozzles of ink jet printers often results from crystallization and deposition of a coloring matter when the moisture of the ink evaporates faster than other solvent and additives in the vicinity of the nozzle to cause a state of the composition including less moisture and a substantive amount of the solvent and additives. Therefore, one extremely important expected performance is that crystals are less likely to be deposited even when the ink is evaporated to dryness. Moreover, on this ground, high solubility in the solvent and additives is also a property required for coloring matters.

In the meantime, for recording image or character information on a color display of computers in full color by an ink jet printer, subtractive color mixing with four inks having different colors, generally yellow (Y), magenta (M), cyan (C), and black (K) has been employed, whereby the recorded image is presented in full color. In order to reproduce an additive color mixing image formed with red (R), green (G), blue (B) on a CRT (cathode ray tube) display and the like as strictly as possible using subtractive color mixing, it is desired that Y, M and C, among the coloring matters used in inks, have a hue approximate to the standard, and are brilliant, respectively. In addition, long term storage stability, as well as high density of the recorded image, and superior fastness such as water resistance, moisture resistance, light resistance and gas resistance are also required for the inks. Herein, gas resistance means resistance to a phenomenon of causing discoloration of a printed image via a reaction of an oxidizing gas present in the air and having an oxidizing action such as SOx gas, NOx gas and ozone gas with a coloring matter (dye) of the recorded image on the record-receiving material or in the record-receiving material. Particularly, ozone gas is considered as a main causative substance that promotes the fading phenomenon of ink jet recorded images. Since this discoloration phenomenon is characteristic in ink jet images, improvement of the ozone gas resistance is a significant technical problem in the art.

As a yellow coloring matter for ink jet recording that is superior in water solubility and brilliance, C. I. (Color Index) Direct Yellow 132 is exemplified, and Patent Documents 1 to 3 disclose examples of its application.

In addition, Patent Documents 4 and 5 disclose an azo yellow coloring matter for ink jet recording having superior fastness properties.

Patent Document 1: Japanese Unexamined Patent Application No. H11-70729

Patent Document 2: Japanese Unexamined Patent Application No. 2000-154344, Examples A1 to A5

Patent Document 3: Japanese Unexamined Patent Application No. 2003-34763, page 24, Table 1-1, Example 4

Patent Document 4: PCT International Publication No. 98/12264

Patent Document 5: PCT International Publication No. 2004/007618

### DISCLOSURE OF THE INVENTION

### Problems to be Solved by the Invention

C. I. Direct Yellow 132 does not necessarily have sufficient performances in all terms of its hue, brilliance, and various fastness properties such as light resistance, as well as storage stability. In addition, the yellow coloring matter disclosed in Patent Document 4 has a very high level of light resistance, but the ozone resistance is still unsatisfactory. Moreover, it has low water solubility and exhibits unfavorable long-term storage stability of the ink. Therefore, development of a yellow coloring matter in attempts to still further improve fastness properties, storage stability of the ink, as well as color density, hue, brilliance, etc., has been desired.

An object of the present invention is to provide a water soluble yellow coloring matter (compound) having high solubility in water, and hue and brilliance suited for ink jet recording, and also having a high color density, and being superior in various fastness properties of the recorded image such as water resistance and moisture resistance, particularly gas resistance and light resistance, and to provide an ink composition having favorable storage stability which contains the same.

### Means for Solving the Problems

In order to solve the foregoing problems, the present inventors thoroughly investigated, and consequently found that a water soluble disazo compound represented by a certain formula, and an ink composition containing the same as a coloring matter solve the problems described above. Thus, the present invention was completed.

Accordingly, a first aspect of the present invention provides a water soluble azo compound represented by the following formula (1) or a salt thereof,

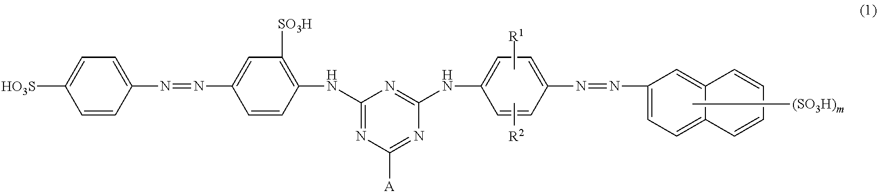

wherein,

R¹ and R² each independently represent a hydrogen atom, an alkyl group having 1 to 4 carbon atoms, or an alkoxy group having 1 to 4 carbon atoms;

m represents an integer of 1 to 3; and

the group A represents an amine residue represented by any one of the following formulae (2) to (5).

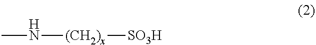

wherein, x represents an integer of 1 to 3.

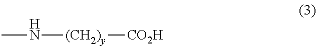

wherein, y represents an integer of 1 to 11.

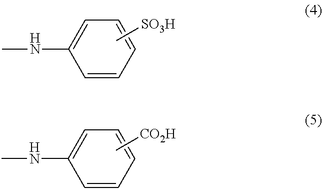

A second aspect of the invention provides the azo compound or a salt thereof according to the first aspect, wherein: R¹ and R² in the formula (1) are both a hydrogen atom; and m is 2.

A third aspect of the invention provides the azo compound or a salt thereof according to the second aspect, wherein the group A in the formula (1) is represented by the formula (2) or (3).

A fourth aspect of the invention provides the azo compound or a salt thereof according to the second aspect, wherein the group A in the formula (1) is represented by the formula (4).

A fifth aspect of the invention provides an ink composition containing the water soluble azo compound or a salt thereof according to any one of the first to fourth aspects as a coloring matter.

A sixth aspect of the invention provides the ink composition according to the fifth aspect further containing a water soluble organic solvent.

A seventh aspect of the invention provides the ink composition according to the fifth or sixth aspect for use in ink jet recording.

An eighth aspect of the invention provides an ink jet recording method including discharging ink droplets in response to recording signals using the ink composition according to any one of the fifth to seventh aspects as an ink to execute recording on a record-receiving material.

A ninth aspect of the invention provides the ink jet recording method according to the eighth aspect, wherein the record-receiving material is a sheet for distributing information.

A tenth aspect of the invention provides the ink jet recording method according to the ninth aspect, wherein the sheet for distributing information is a sheet having an ink receiving layer containing a porous white inorganic substance.

An eleventh aspect of the invention provides a colored body which was colored with the water soluble azo compound or a salt thereof according to any one of the first to fourth aspects, or with the ink composition according to any one of the fifth to seventh aspects.

A twelfth aspect of the invention provides the colored body according to the eleventh aspect, wherein the coloring was carried out with an ink jet printer.

A thirteenth aspect of the invention provides an ink jet printer equipped with a vessel containing the ink composition according to any one of the fifth to seventh aspects.

### EFFECTS OF THE INVENTION

The water soluble azo compound represented by the above formula (1) or a salt thereof of the present invention is extremely superior in solubility in water as compared with conventional products. Additionally, the compound is characterized by having favorable filterability on, for example, membrane filters, in the step of producing an ink composition, thereby providing a hue of a very brilliant yellow color with a high brightness and color density on an ink jet recording paper. Moreover, an ink composition of the present invention containing this compound exhibits extremely favorable storage stability as compared with conventional products, without crystal deposition, physical property alteration, change in the hue and the like after storage for a long period of time. Furthermore, a printed matter obtained using the ink composition of the present invention as an ink for ink jet recording has an ideal hue as a yellow color hue without limitation of usable record-receiving material (for example, paper, film, etc.), and further photographic color images can be strictly reproduced on paper. Additionally, even though recording is carried out on a record-receiving material including a porous white inorganic substance coated on its surface, such as an exclusive ink jet paper for photo image quality and a film, favorable various fastness properties such as water resistance and moisture resistance, particularly gas resistance and light resistance, as well as superior long-term storage stability of photographic recorded image can be achieved. Accordingly, the water soluble azo compound represented by the formula (1) or a salt thereof is extremely useful as a yellow coloring matter for inks, particularly for inks for ink jet recording.

### PREFERRED MODE FOR CARRYING OUT THE INVENTION

The present invention is explained in detail below. Unless otherwise stated in particular herein, acidic functional groups such as sulfo groups and carboxy groups are represented in the form of their free acids. In addition, the water soluble azo compound or a salt thereof of the present invention is a water soluble yellow coloring matter.

In the following description, unless otherwise stated in particular, “the water soluble azo compound or a salt thereof of the present invention” is expediently referred to as “the water soluble azo compound of the present invention” to include the compound and salt in order to avoid complexity.

The water soluble azo compound of the present invention is represented by the following formula (1).

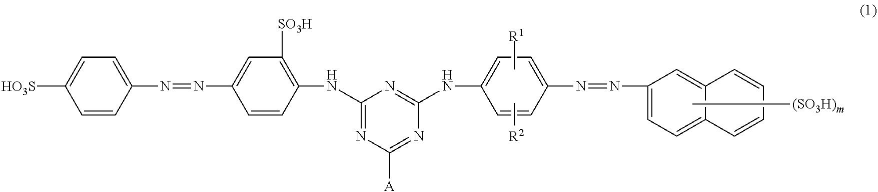

In the formula (1), R¹ and R² each independently represent a hydrogen atom, an alkyl group having 1 to 4 carbon atoms, or an alkoxy group having 1 to 4 carbon atoms; m represents an integer of 1 to 3, and the group A represents an amine residue represented by any one of the following formulae (2) to (5).

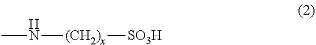

In the formula (2), x represents an integer of 1 to 3.

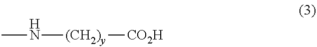

In the formula (3), y represents an integer of 1 to 11.

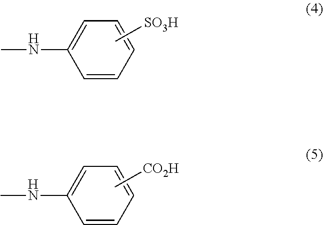

The alkyl group having 1 to 4 carbon atoms in R¹ and R² may be either straight or branched alkyl group, but straight alkyl groups are more preferred. Specific examples of preferable alkyl group include straight alkyl groups such as methyl, ethyl, n-propyl and n-butyl; and branched alkyl groups such as isopropyl, isobutyl, 1-methylpropyl and t-butyl. More preferably, the alkyl group is methyl.

The alkoxy group having 1 to 4 carbon atoms may be either straight or branched alkyl group, but straight alkoxy groups are more preferred. Specific examples of preferable alkoxy group include straight alkoxy groups such as methoxy, ethoxy, n-propoxy and n-butoxy; and branched alkoxy groups such as isopropoxy, isobutoxy, 1-methylpropoxy and t-butoxy. More preferably, the alkoxy group is methoxy.

As the combination of R¹ and R², any combinations selected from a hydrogen atom, methyl and methoxy are preferred. Compounds in which at least one of these is a hydrogen atom are more preferred, and compounds in which both of these are a hydrogen atom are still more preferred.

m is generally an integer of 1 to 3, and preferably 2.

When the group A in the above formula (1) is represented by the above formula (2), x in the formula (2) represents an integer of 1 to 3. x is preferably 2.

When the group A in the above formula (1) is represented by the above formula (3), y in the formula (3) represents an integer of 1 to 11. y is preferably an integer of 1 to 6, more preferably an integer of 3 to 6, still more preferably an integer of 4 to 6, and particularly preferably 5.

As the group A in the above formula (1), any of the groups represented by the above formulae (2) to (5) is preferred, but the group A in the above formula (1) is represented more preferably by the above formulae (2) to (4), still more preferably by the above formula (2) or (3), and particularly preferably by the above formula (2). Furthermore, with respect to the aforementioned R¹, R², m, and group A, compounds in which preferable options are combined are more preferred, and compounds in which more preferable options are combined are still more preferred. In addition, compounds in which still more preferable options are combined are similarly even more preferred.

The compound represented by the above formula (1) is present in the form of either a free acid or a salt thereof. The salt of the compound represented by the above formula (1) may be a salt with an inorganic or organic cation. Specific examples of the inorganic cation salt include alkali metal salts, for example, salts with lithium, sodium, potassium or the like. Furthermore, specific examples of the organic cation salt include, for example, salts with a quaternary ammonium compound represented by the following formula (6) but not limited thereto.

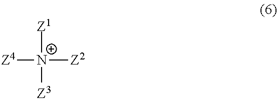

In the formula (6), Z¹ to Z⁴ each independently represent a hydrogen atom, a C1-C4 alkyl group, a hydroxy(C1-C4)alkyl group, or a hydroxy(C1-C4)alkoxy(C1-C4)alkyl group.

Wherein, examples of the C1-C4 alkyl group in Z¹ to Z⁴ include methyl, ethyl and the like; examples of the hydroxy(C1-C4)alkyl group include hydroxymethyl, hydroxyethyl, 3-hydroxypropyl, 2-hydroxypropyl, 4-hydroxybutyl, 3-hydroxybutyl, 2-hydroxybutyl and the like; and further, examples of the hydroxy(C1-C4)alkoxy(C1-C4)alkyl group include hydroxyethoxymethyl, 2-hydroxyethoxyethyl, 3-(hydroxyethoxy)propyl, 3-(hydroxyethoxy)butyl, 2-(hydroxyethoxy)butyl and the like.

Among the aforementioned salts, preferable salts include sodium, potassium, lithium, monoethanolamine, diethanolamine, triethanolamine, monoisopropanolamine, diisopropanolamine and triisopropanolamine salts, ammonium salts, and the like. Of these, particularly preferred are lithium, sodium, potassium, and ammonium salts.

As is apparent to persons skilled in the art, the salt of the compound represented by the above formula (1) can be readily obtained by the following method and the like.

For example, sodium chloride is added to a reaction liquid before adding 800 parts of acetone in Example 1 described later, or to an aqueous solution dissolving wet cake containing the compound represented by the formula (1) or a dried matter containing the compound represented by the formula (1), or the like, whereby salt precipitation is executed, followed by filtration of the deposited solid. Accordingly a sodium salt of the compound represented by the above formula (1) can be obtained as a wet cake.

In addition, after dissolving the wet cake of the resulting sodium salt in water, an acid such as hydrochloric acid is added to adjust the pH appropriately, followed by filtration of the deposited solid, whereby a free acid of the compound represented by the above formula (1) can be obtained, or a mixture of a free acid and a sodium salt in which a part of the compound represented by the formula (1) is a sodium salt can be obtained alternatively.

Alternatively, when for example, potassium hydroxide, lithium hydroxide, aqueous ammonia, a hydroxide or the like of the compound represented by the above formula (6) is added while a wet cake of the free acid of the compound represented by the formula (1) is stirred with water to make the solution alkaline, each corresponding potassium salt, lithium salt, ammonium salt, or quaternary ammonium salt can be obtained. By limiting the number of moles of the aforementioned salt added, with respect to the number of moles of the free acid, preparation of for example, mixed salts etc., of lithium and sodium, as well as mixed salts etc., of lithium, sodium, and ammonium is also enabled. The salt of the compound represented by the above formula (1) may have varying physical properties such as solubility, or performance of the ink when used as an ink, depending on the type of the salt. Therefore, selection of the type of the salt is preferably carried out to meet intended ink performance and the like.

The compound of the present invention represented by the above formula (1) can be produced, for example, as in the following. It is to be noted that R¹, R², m, x, and y used suitably in the following formulae (AA) to (K) mean similarly to the definitions in the above formula (1), respectively.

With reference to Example described in the specification of Japanese Unexamined Patent Application No. 2004-75719, the compound represented by the following formula (AA) is converted into a methyl-ω-sulfonic acid derivative (B) using sodium bisulfite and formalin. Next, an aminonaphthalenesulfonic acid represented by the following formula (C) is diazotized by a routine method, and the product is subjected to a coupling reaction at 0 to 15° C. and a pH of 2 to 4 with the methyl-ω-sulfonic acid derivative represented by the formula (B) obtained above, and subsequently subjected to a hydrolyzing reaction at 80 to 95° C. and a pH of 10.5 to 11.5 to obtain a compound represented by the following formula (D).

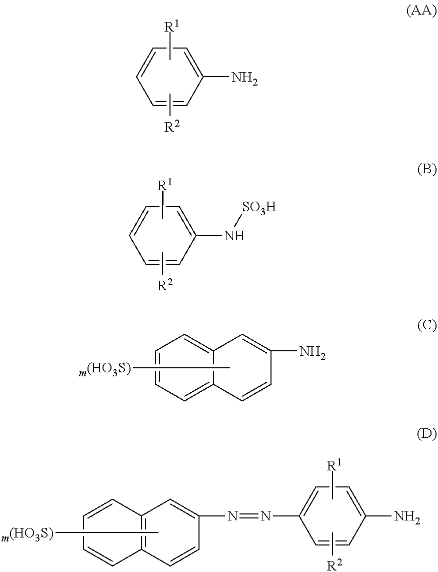

Next, 1 equivalent of an azo compound represented by the following formula (E) (available as a commercial product manufactured by Chemco International) is condensed with cyanuric halide, for example, cyanuric chloride under a weakly acidic condition of a temperature of 0 to 20° C. and a pH of 5 to 7 to obtain a compound represented by the following formula (F). Subsequently, one equivalent of the compound represented by the formula (D) obtained above is condensed with the compound represented by the formula (F) under a weakly acidic condition of a temperature of 20 to 50° C. and a pH of 6 to 7 to obtain a compound represented by the following formula (G).

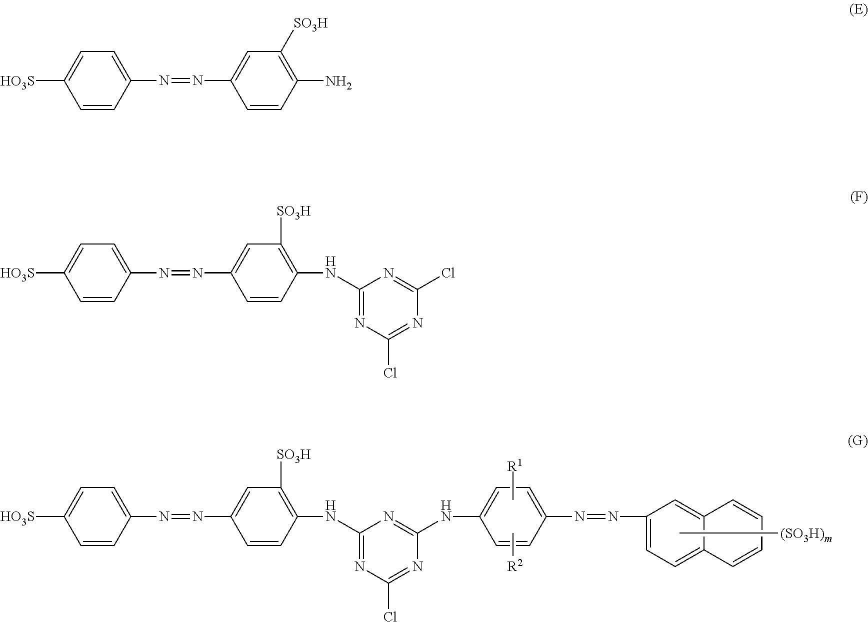

The water soluble azo compound of the present invention represented by the above formula (1) can be obtained by further substituting a chlorine atom in the obtained compound represented by the above formula (G) with each of compounds represented by the following formulae (H) to (K) preferably under a condition of a 75 to 90° C. and a pH of 7 to 9.

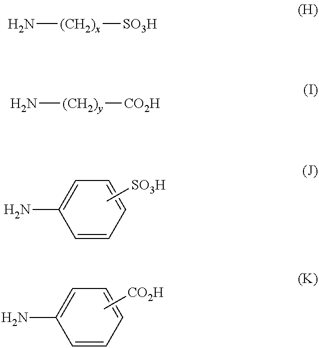

The compound represented by the above formula (AA) includes aniline, 3-methylaniline, 2-methylaniline, 2-methoxyaniline, 3-methoxyaniline, 2,5-dimethyl aniline, 2-methoxy-5-methylaniline, 2,5-dimethoxy aniline, and the like. Among these, aniline, 3-methylaniline and 2-methoxyaniline are preferred. The compound represented by the above formula (C) includes 2-aminonaphthalene-4,8-disulfonic acid, 2-aminonaphthalene-5,7-disulfonic acid, 2-aminonaphthalene-6,8-disulfonic acid, 2-aminonaphthalene-6-sulfonic acid, and the like.

Moreover, the compound represented by the above formula (H) includes aminomethylsulfonic acid, taurine, homotaurine, and the like. Among these, taurine is preferred. The compound represented by the above formula (I) includes glycine, β-alanine, 4-aminobutyric acid, 5-aminovaleric acid, 6-aminohexanoic acid, 7-aminoheptanoic acid, 12-aminododecanoic acid, and the like. The compound represented by the above formula (J) includes 3-aminobenzenesulfonic acid, 4-aminobenzenesulfonic acid, and the like. Among these, 3-aminobenzenesulfonic acid is preferred. The compound represented by the above formula (K) includes 3-aminobenzoic acid, 4-aminobenzoic acid, and the like.

Next, specific examples of preferable coloring matter of the present invention are shown in Table 1 below. In Table 1, the acidic functional group such as a sulfo group is represented in the form of its free acid.

TABLE 1
Compound Examples

| Compound | Structural formula | | | | | |
|---|---|---|---|---|---|---|
| Number | R1 | R2 | m | x | y | |
| 1 | H | H | 2 | 1 | — | 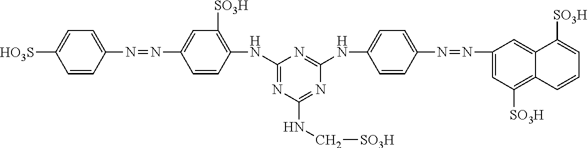 |
| 2 | H | H | 2 | 2 | — | 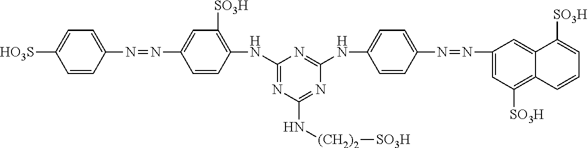 |
| 3 | H | H | 2 | 3 | — | 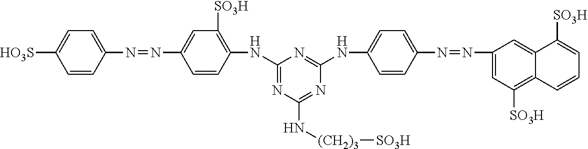 |
| 4 | H | H | 2 | — | 1 | 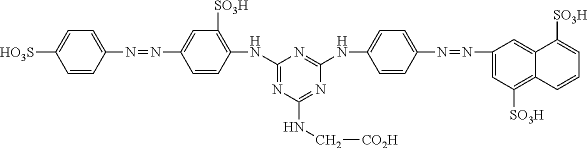 |
| 5 | H | H | 2 | — | 2 | 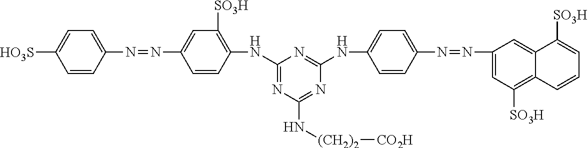 |
| 6 | H | H | 2 | — | 3 | 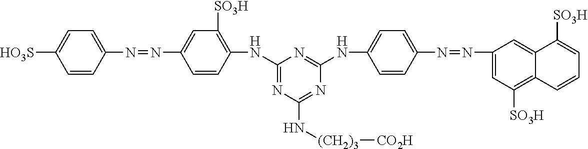 |
| 7 | H | H | 2 | — | 4 | 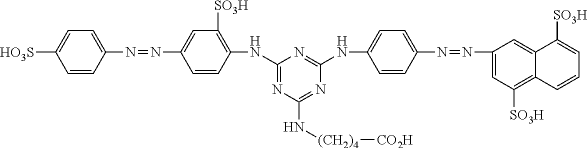 |
| 8 | H | H | 2 | — | 5 | 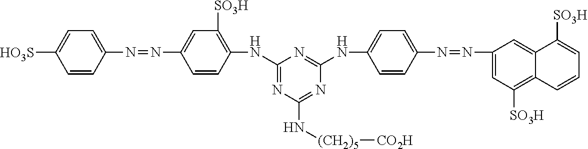 |
| 9 | H | H | 2 | — | 6 | 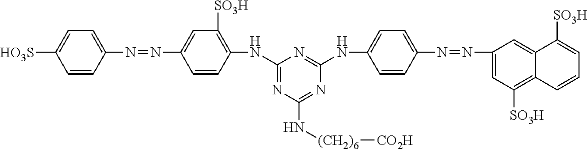 |
| 10 | H | H | 2 | — | 11 | 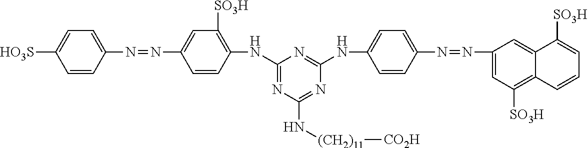 |
| 11 | H | H | 2 | — | — | 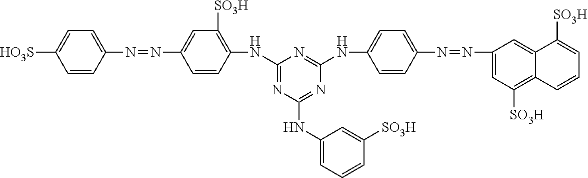 |
| 12 | H | H | 2 | — | — | 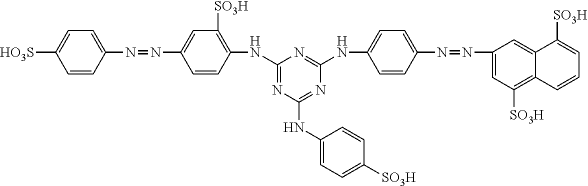 |
| 13 | H | H | 2 | — | — | 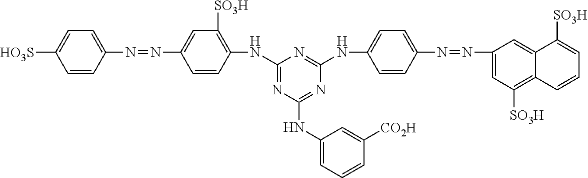 |
| 14 | H | H | 2 | — | — | 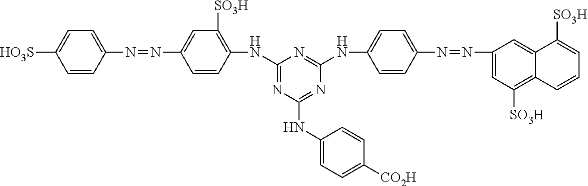 |
| 15 | Me | H | 2 | 2 | — | 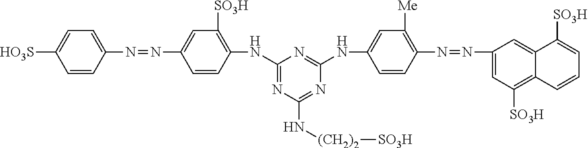 |
| 16 | Me | H | 2 | 2 | — | 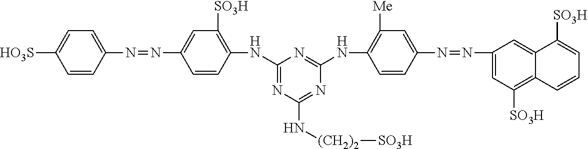 |
| 17 | MeO | H | 2 | 2 | — | 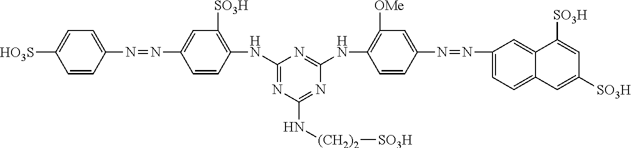 |
| 18 | MeO | H | 2 | 2 | — | 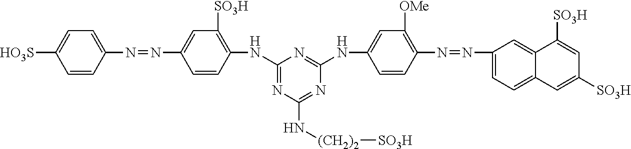 |
| 19 | Me | Me | 2 | 2 | — | 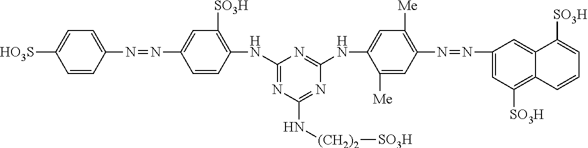 |
| 20 | MeO | Me | 2 | 2 | — | 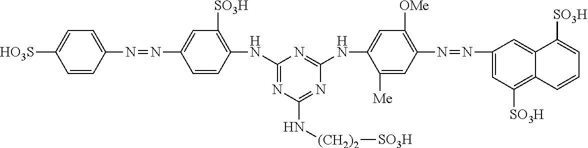 |
| 21 | MeO | MeO | 2 | 2 | — | 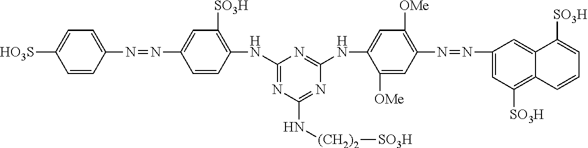 |
| 22 | H | H | 3 | 2 | — | 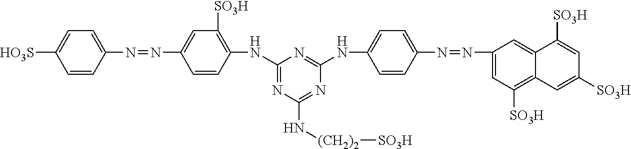 |
| 23 | H | H | 2 | 2 | — | 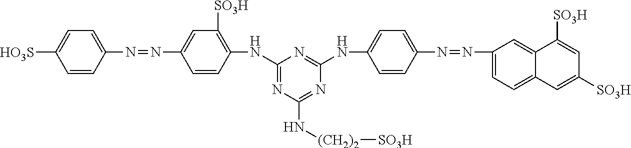 |
| 24 | H | H | 2 | 2 | — | 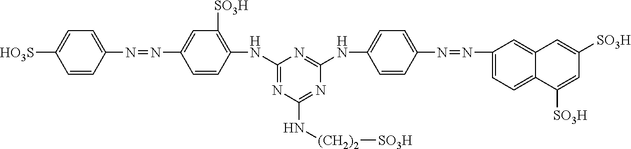 |
| 25 | H | 3 | 1 | 2 | — | 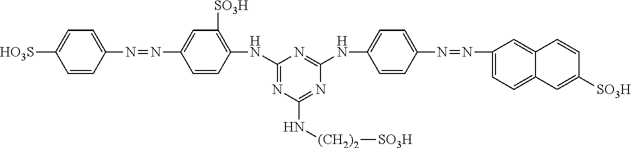 |

The compound of the present invention represented by the above formula (1) can be isolated in the form of a solid free acid by adding a mineral acid such as hydrochloric acid following the coupling reaction, and inorganic salts such as e.g., sodium chloride and sodium sulfate contained as impurities can be removed by washing the obtained solid free acid with water or acidic water such as aqueous hydrochloric acid, or the like.

The free acid of the water soluble azo compound of the present invention obtained as described above may be subjected to a treatment with a desired inorganic or organic base in an aqueous medium, whereby a solution of the corresponding salt of the compound can be obtained. The aqueous medium means, in general, a mixed solution of a water soluble organic solvent and water.

The inorganic base includes hydroxides of an alkali metal such as lithium hydroxide, sodium hydroxide and potassium hydroxide, carbonates of an alkali metal such as lithium carbonate, sodium carbonate and potassium carbonate, or ammonium hydroxide (aqueous ammonia), and the like.

Examples of the organic base include salts of a quaternary ammonium represented by the above formula (6), for example, salts of alkanolamine such as diethanolamine or triethanolamine, and the like, but not limited thereto.

The coloring matter of the present invention is suited for staining of natural and synthetic fiber materials or blended fabric products, and further for production of ink compositions of inks for ink jet recording and writing inks.

The reaction liquid containing the water soluble azo compound of the present invention (for example, reaction liquid before charging 800 parts of acetone in Example 1 described later, etc.) may be also used directly for producing an ink composition of the present invention. Alternatively, after isolating the compound from the reaction liquid by, for example, crystallization, spray drying or the like, followed by drying as needed, the resulting compound can be used to prepare an ink composition. The ink composition of the present invention contains the water soluble azo compound of the present invention as a coloring matter in an amount of usually 0.1 to 20% by mass, more preferably 1 to 10% by mass, and still more preferably 2 to 8% by mass in the total mass of the ink composition.

The ink composition of the present invention is prepared by dissolving the compound represented by the above formula (1) in an aqueous medium such as water and/or a water soluble organic solvent (organic solvent that is miscible with water), and adding thereto an ink adjusting agent as needed. When the ink composition is used as an ink for ink jet printer, the content of inorganic impurities such as metal cation chlorides (for example, sodium chloride etc.) and sulfuric acid salts (sodium sulfate etc.) is preferably as low as possible. In this regard, the total content of, for example, sodium chloride and sodium sulfate accounts for about no greater than 1% by mass in total mass of the water soluble azo compound of the present invention. For the production of the compound including less inorganic impurities, for example, a desalination treatment may be carried out with a method with a reverse osmotic membrane well-known per se. The desalination treatment can be also executed by other method in which a dried matter or wet cake of the compound or a salt thereof of the present invention is stirred in a mixed solvent of an alcohol such as methanol and water to give a suspension, and the solid is collected by filtration followed by drying.

The ink composition of the present invention is prepared with water as a medium, and may contain a water soluble organic solvent as needed in the range not to deteriorate the effects of the present invention. The water soluble organic solvent is used as a dye solubilizer, a drying-preventive agent (wetting agent), a viscosity adjusting agent, a permeation accelerating agent, a surface tension adjusting agent, a defoaming agent and the like, and it is preferred that the water soluble organic solvent is contained in the ink composition of the present invention. The other ink preparation agent includes well-known additives such as, for example, a preservative and fungicide, a pH adjusting agent, a chelating reagent, a rust-preventive agent, an ultraviolet ray absorbing agent, a viscosity adjusting agent, a dye solubilizer, a discoloration-preventive agent, an emulsification stabilizer, a surface tension adjusting agent, a defoaming agent, a dispersant, and a dispersion stabilizer. The content of the water soluble organic solvent is 0 to 60% by mass, and preferably 10 to 50% by mass of the entire ink, whereas the ink preparation agent may be used in an amount of 0 to 20% by mass, and preferably 0 to 15% by mass of the entire ink. The remaining component is water.

The water soluble organic solvent usable in the present invention may be, for example: a (C1-C4)alkanol such as methanol, ethanol, n-propanol, isopropanol, n-butanol, isobutanol, secondary butanol and tertiary butanol; an amide such as N,N-dimethylformamide and N,N-dimethylacetamide; heterocyclic ketone such as 2-pyrrolidone, N-methyl-2-pyrrolidone, 1,3-dimethylimidazolidine-2-one and 1,3-dimethylhexahydropyrimido-2-one; ketone or a keto alcohol such as acetone, methylethylketone and 2-methyl-2-hydroxypentane-4-one; a cyclic ether such as tetrahydrofuran and dioxane; a mono, oligo, or polyalkylene glycol or thioglycol having a (C2-C6)alkylene unit such as ethylene glycol, 1,2- or 1,3-propylene glycol, 1,2- or 1,4-butylene glycol, 1,6-hexylene glycol, diethylene glycol, triethylene glycol, tetraethylene glycol, dipropylene glycol, polyethylene glycol, polypropylene glycol and thiodiglycol; polyol (triol) such as glycerin and hexane-1,2,6-triol; (C1-C4)monoalkyl ether of a polyhydric alcohol such as ethylene glycol monomethyl ether, ethylene glycol monoethyl ether, diethylene glycol monomethyl ether, diethylene glycol monoethyl ether, diethylene glycol monobutyl ether (butylcarbitol), triethylene glycol monomethyl ether and triethylene glycol monoethyl ether; y-butyrolactone, dimethyl sulfoxide, and the like.

As the water soluble organic solvent, preferable examples include isopropanol, glycerin, mono-, di-, or tri-ethylene glycol, dipropylene glycol, 2-pyrrolidone, N-methyl-2-pyrrolidone, and butylcarbitol, whereas more preferable examples include isopropanol, glycerin, diethylene glycol, 2-pyrrolidone, N-methyl-2-pyrrolidone, and butylcarbitol. These water soluble organic solvents are used either alone or as a mixture.

The preservative and fungicide may include, for example, a compound of organic sulfur based, organic nitrogen sulfur based, organic halogen based, haloallyl sulfone based, iodopropargyl based, N-haloalkylthio based, benzothiazole based, nitrile based, pyridine based, 8-oxyquinoline based, isothiazoline based, dithiol based, pyridineoxide based, nitropropane based, organic tin based, phenol based, quaternary ammonium salt based, triazine based, thiadiazine based, anilide based, adamantane based, dithiocarbamate based, brominated indanone based, benzylbromoacetate based, or the like.

The organic halogen based compound may include, for example, sodium pentachlorophenol; the pyridineoxide based compound may include, for example, sodium 2-pyridinethiol-1-oxide; and the isothiazoline based compound may include, for example, 1,2-benzisothiazoline-3-one, 2-n-octyl-4-isothiazoline-3-one, 5-chloro-2-methyl-4-isothiazoline-3-one, 5-chloro-2-methyl-4-isothiazoline-3-onemagnesiumchloride, 5-chloro-2-methyl-4-isothiazoline-3-onecalciumchloride, 2-methyl-4-isothiazoline-3-onecalciumchloride, and the like.

The other preservative and fungicide may be sodium sorbate, sodium acetate, sodium benzoate, and the like. Other specific examples of preferable preservative and fungicide include e.g., trade names Proxel GXL (S), Proxel XL-2 (S) manufactured by Avecia Limited, and the like.

The pH adjusting agent may be used for the purpose of improving storage stability of the ink, and an arbitrary substance can be used as long as the pH of the ink can be controlled to fall within the range of 6.0 to 11.0 Examples of the pH adjusting agent include alkanolamines such as diethanolamine and triethanolamine, hydroxides of an alkali metal such as lithium hydroxide, sodium hydroxide and potassium hydroxide, ammonium hydroxide as well as carbonates of an alkali metal such as lithium carbonate, sodium carbonate and potassium carbonate, and the like.

The chelating agent may include, for example, sodium ethylenediamine tetraacetate, sodium nitrilo triacetate, sodium hydroxyethylethylenediamine triacetate, sodium diethylenetriamine pentaacetate, sodium uracil diacetate, and the like.

The rust-preventive agent may include, for example, acidic sulfite, sodium thiosulfate, ammonium thioglycolate, diisopropylammonium nitrite, pentaerythritol tetranitrate, dicyclohexylammonium nitrite, and the like.

Examples of the ultraviolet ray absorbing agent include benzophenone based compounds, benzotriazole based compounds, cinnamic acid based compounds, triazine based compounds, stilbene based compounds, and the like. In addition, a fluorescent whitening agent generally referred to, which is a compound that absorbs an ultraviolet ray to emit fluorescence, and which is typified by a benzoxazole based compound may be used.

The viscosity adjusting agent may include in addition to a water soluble organic solvent, a water soluble polymer compound, and specific examples include polyvinyl alcohols, cellulose derivatives, polyamine, polyimine, and the like.

The dye solubilizer may include, for example, urea, ε-carpolactam, ethylene carbonate, and the like. It is preferred to use urea.

The discoloration-preventive agent is used for the purpose of improving storability of the image. As the discoloration-preventive agent, a variety of organic and metal complex based discoloration-preventive agents may be used. Examples of the organic discoloration-preventive agent include hydroquinones, alkoxyphenols, dialkoxyphenols, phenols, anilines, amines, indanes, chromanes, alkoxyanilines, heterocycles and the like, whereas examples of the metal complex include nickel complexes, zinc complexes and the like.

As the surface tension adjusting agent, surfactants may be exemplified, and examples include anionic surfactants, amphoteric surfactants, cationic surfactants, nonionic surfactants, and the like.

Examples of the anionic surfactant include alkylsulfocarboxylic acid salts, a-olefinsulfonic acid salts, polyoxyethylenealkyl ether acetic acid salts, N-acylamino acid and salts thereof, N-acylmethyltaurine salts, alkylsulfuric acid salts, polyoxyalkyl ether sulfuric acid salts, alkylsulfuric acid salts, polyoxyethylenealkyl ether phosphoric acid salts, resin acid soap, castor oil sulfate ester salts, lauryl alcohol sulfate ester salts, alkylphenolic phosphate esters, alkylated phosphate esters, alkylarylsulfonic acid salts, diethyl sulfosuccinic acid salts, diethylhexyl sulfosuccinic acid salts, dioctyl sulfosuccinic acid salts, and the like.

Examples of the cationic surfactant include 2-vinylpyridine derivatives, poly4-vinylpyridine derivatives, and the like.

Examples of the amphoteric surfactant include betaine lauryldimethylamino acetate, 2-alkyl-N-carboxymethyl-N-hydroxyethylimidazolinium betaine, betaine coconut oil fatty acid amidepropyldimethylamino acetate, polyoctylpolyaminoethylglycine, imidazoline derivatives, and the like.

Examples of the nonionic surfactant include: ether based surfactants such as polyoxyethylene nonylphenyl ether, polyoxyethylene octylphenyl ether, polyoxyethylene dodecyl phenyl ether, polyoxyethylene oleyl ether, polyoxyethylene lauryl ether and polyoxyethylene alkyl ether; ester based surfactants such as polyoxyethylene oleate esters, polyoxyethylene distearate esters, sorbitan laurate, sorbitan monostearate, sorbitan monooleate, sorbitan sesquioleate, polyoxyethylene monooleate and polyoxyethylene stearate; acetylene alcohol based surfactants such as 2,4,7,9-tetramethyl-5-decyne-4,7-diol, 3,6-dimethyl-4-octyne-3,6-diol and 3,5-dimethyl-1-hexine-3-ol; and other specific examples include trade names Surfinol 104, 82, 465, Olfin STG manufactured by Nissin Chemical Co., Ltd., and the like.

As the defoaming agent, a highly oxidized oil based compound, glycerin fatty acid ester based compound, fluorine based compound, silicone based compound or the like may be used as needed.

These ink preparation agents may be used either alone or as a mixture. The surface tension of the ink composition of the present invention is usually 25 to 70 mN/m, and more preferably 25 to 60 mN/m. In addition, the viscosity of the ink composition of the present invention is adjusted to preferably no greater than 30 mPa·s, and more preferably no greater than 20 mPa·s.

In production of the ink composition of the present invention, the order of dissolving each reagent such as additives is not particularly limited. When the composition is prepared, water employed preferably includes impurities in an amount as low as possible, and thus water such as ion exchanged water or distilled water is preferred. Furthermore, precision filtration may be carried out to remove contamination, as needed, using a membrane filter or the like. In particular, when the ink is used as an ink for ink jet printers, carrying out the precision filtration is preferred. The filter for carrying out precision filtration has a pore size of usually 1 to 0.1 μm, and preferably 0.5 to 0.1 μm.

The ink composition containing the water soluble azo compound of the present invention is suited for use in printing, copying, marking, describing, drawing, stamping, or recording (printing), and particularly in ink jet recording. In addition, the ink composition of the present invention is less likely to be deposited as crystals even though dried in the vicinity of the nozzle of an ink jet printer, and therefore, clogging of the printer head is also less likely to occur based on the same reason. Moreover, when the ink composition of the present invention is used for ink jet recording, yellow printed matters with a high quality and high color density having favorable resistance to water, light, ozone or nitrogen oxide gas and friction are obtained.

In some ink jet printers, two kinds of inks, i.e., a high density ink and a low density ink are loaded in one printer, for the purpose of supplying a high definition image. In this instance, a high density ink composition and a low density ink composition are prepared respectively using the water soluble azo compound of the present invention, and these may be used in combination as an ink set. Alternatively, the present compound may be used in either one of them. Furthermore, the water soluble azo compound of the present invention and a well-known yellow coloring matter may be used in combination. In addition, the coloring matter of the present invention may be also used for the purpose of color conditioning of other colors, for example, of a black ink, or for preparing a red ink or a green ink by blending with a magenta coloring matter or a cyanogen coloring matter.

The colored body of the present invention refers to a substance which was colored with the water soluble azo compound of the present invention or an ink composition containing the compound, or the like. The material entity of the colored body is not particularly limited, and any one is acceptable as long as it can be colored such as for example, a sheet for distributing information such as a paper or film, a fiber or cloth (cellulose, nylon, wool, etc.), a leather, a base material for color filters, but not limited thereto. The coloring method may include, for example, printing methods such as a dip dyeing method, a textile printing method and a screen printing, as well as ink jet recording methods with an ink jet printer, and the like, but the ink jet recording method is preferred.

The sheet for distributing information is preferably paper subjected to a surface treatment, specifically, paper, synthetic paper, films etc., having an ink receiving layer provided on the base material. The ink receiving layer is provided by, for example: a method in which a cation based polymer is impregnated in or coated on the aforementioned base material; a method in which inorganic fine particles that can absorb a coloring matter in an ink such as porous silica, alumina sol or special ceramics are coated on the surface of the aforementioned base material together with a hydrophilic polymer such as polyvinyl alcohol or polyvinylpyrrolidone.

Such sheets provided with an ink receiving layer are generally referred to as ink jet exclusive paper, ink jet exclusive film, glossy paper, glossy film, and the like.

Among these, paper referred to as being susceptible to gasses having an oxidizing action in the air, i.e., ozone gas, nitrogen oxide gas etc., is ink jet exclusive paper produced by coating the aforementioned porous silica, alumina sol, special ceramics or the like on the surface of a base material.

Examples of typical commercially available product of the ink jet exclusive paper include trade names: Professional Photo Paper, Super Photo Paper, and Matte Photo Paper manufactured by Canon, Inc.; trade names: Photo Paper CRISPIA (Super Glossy), Photo Paper (Glossy), and Photo Matte Paper manufactured by Seiko Epson Corporation; trade name: Advanced Photo Paper (Glossy) manufactured by Hewlett-Packard Japan, Ltd.; trade name: KASSAI SHASHIN-SHIAGE Pro manufactured by FUJIFILM Corporation; and the like.

Since the ink composition of the present invention is superior in resistance to the gas having an oxidizing action as described above, superior recorded images accompanied by less discoloration can be provided even when recorded on such a type of record-receiving materials. In addition, the composition can be also used for plain paper.

For recording on a record-receiving material with the ink jet recording method of the present invention, for example, a vessel filled with the ink composition is attached at a specified position of an ink jet printer, and the recording may be executed by a conventional method on the record-receiving material. In the ink jet recording method of the present invention, a magenta ink, a cyan ink, as well as if necessary, a green ink, a blue (or violet) ink, a red ink, a black ink and the like may be used in combination with the ink composition of the present invention. In this case, the ink of each color is injected into each vessel, and the vessels are attached at a specified position of the ink jet printer and then used.

There are ink jet printers in which, for example, a piezo system utilizing mechanical vibration; a bubble jet (registered trademark) system utilizing bubbles generated by heating; or the like is adopted. The ink jet recording method of the present invention can be employed according to any system.

The ink composition of the present invention has a brilliant yellow color, provides a high contrast ratio and color density of the image recorded particularly on an ink jet exclusive paper or a glossy paper, and has a hue suited for ink jet recording methods. In addition, the ink composition is characterized by having superior fastness of the recorded image, in particular, striking moisture resistance, light resistance, and ozone gas resistance.

The ink composition of the present invention is precluded from precipitation and separation during storage, thereby capable of providing extremely favorable storage stability. Additionally, when the ink composition of the present invention is used in ink jet recording, deposition of crystals due to drying of the ink composition in the vicinity of the nozzle hardly occurs, and clogging of the injector (ink head) can be also avoided. The ink composition of the present invention does not cause alteration of physical properties even in the case in which: the ink is used by recycling with a comparatively long time interval using a continuous ink jet printer; the ink is intermittently used with an on-demand ink jet printer; and the like.

### Examples

Hereinafter, the present invention is more specifically described by way of Examples. In the specification, the expressions “part” and “%” are on the basis of the mass unless otherwise stated particularly, and the reaction temperature means an interior temperature also unless otherwise stated. Each operation of reaction, crystallization and the like in Examples was carried out under stirring unless otherwise stated particularly.

It should be noted that Amax (wavelength of maximum absorption) of each compound synthesized shows the value of measurement in an aqueous solution of pH 7 to 8 in the range of 300 to 800 nm. Moreover, although any of the water soluble azo compound of the present invention obtained in Examples is a sodium salt, the chemical structural formula thereof is represented in the form of its free acid for the sake of simplicity. However, alkali metal salts other than the free acids, sodium salts and the like can be readily obtained using appropriate methods as described above, and the present invention is not limited to the Examples.

### Example 1

### (Step 1)

2-Aminonaphthalene-4,8-disulfonic acid in an amount of 30.3 parts was dissolved in 200 parts of water while adjusting the pH to 6 with sodium hydroxide, and then 7.2 parts of sodium nitrite was added thereto. After this solution was added dropwise to 300 parts of 5% hydrochloric acid at 0 to 10° C. over 30 min, the mixture was stirred at no higher than 10° C. for 1 hour to carry out a diazotization reaction, whereby a diazo reaction liquid was prepared.

On the other hand, 9.3 parts of aniline was converted into a methyl-ω-sulfonate derivative using 130 parts of water, 10.4 parts of sodium bisulfite, and 8.6 parts of 35% formalin by a routine method.

Thus obtained methyl-ω-sulfonate derivative was added to the diazo reaction liquid prepared beforehand, and the mixture was stirred at 0 to 15° C. and a pH of 2 to 4 for 5 hrs. After the pH of the reaction liquid was adjusted to 11 with sodium hydroxide, the liquid was stirred while maintaining the same pH at 80 to 95° C. for 5 hrs, and further 100 parts of sodium chloride was added thereto to allow for salt precipitation. The deposited solid was collected by filtration to obtain 100 parts of a compound represented by the following formula (7) as wet cake.

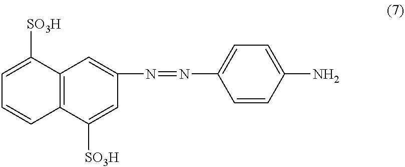

### (Step 2)

Into 250 parts of ice water was added 0.10 parts of Leocol TD90 (trade name, surfactant) manufactured by Lion Corporation, and the mixture was vigorously stirred, to which 12.9 parts of cyanuric chloride was added, followed by stirring at 0 to 5° C. for 30 min to obtain a suspension.

Subsequently, 25.0 parts of a compound represented by the following formula (8) was dissolved in 200 parts of water, and the aforementioned suspension was added dropwise to this solution over 30 min. After completing the dropwise addition, the mixture was stirred at a pH of 5 to 7 and at 0 to 15° C. for 6 hrs to obtain a reaction liquid.

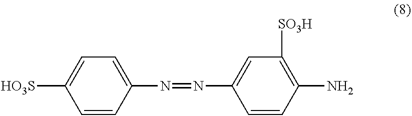

### (Step 3)

The wet cake of the compound represented by the above formula (7) obtained in the above step 1 in an amount of 100 parts was dissolved in 300 parts of water, and the solution was added dropwise to the reaction liquid obtained in the above step 2 over 30 min. After completing the dropwise addition, the mixture was stirred at a pH of 6 to 7 and at 25 to 50° C. for 6 hrs to which 26.3 parts of taurine was added followed by stirring at a pH of 7 to 9 and at 75 to 90° C. for 3 hrs. After cooling the obtained reaction liquid to 20 to 25° C., 800 parts of acetone was added to this reaction liquid, followed by stirring at 20 to 25° C. for 1 hour. Thereafter, the deposited solid was collected by filtration to obtain 120.0 parts of wet cake. This wet cake was dried with a hot-air dryer at 80° C. to obtain 50.0 parts of the water soluble azo compound (Amax: 382 nm) of the present invention represented by the following formula (9).

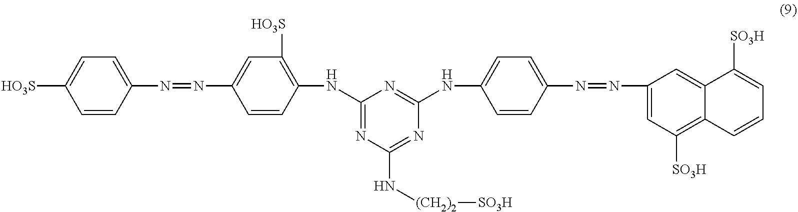

### Example 2

In a similar manner to Example 1 except that 30.3 parts of 2-aminonaphthalene-6,8-disulfonic acid was used in place of 30.3 parts of 2-aminonaphthalene-4,8-disulfonic acid used in the step 1 of Example 1, 50.5 parts of the water soluble azo compound (Amax: 382 nm) of the present invention represented by the following formula (10) was obtained.

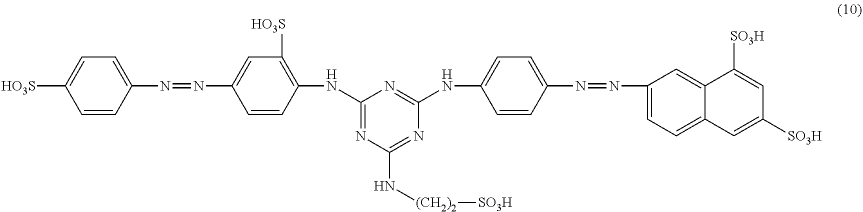

### Example 3

In a similar manner to Example 1 except that 10.7 parts of 3-methylaniline was used in place of 9.3 parts of aniline used in the step 1 of Example 1, 50.0 parts of the water soluble azo compound (Amax: 384 nm) of the present invention represented by the following formula (11) was obtained.

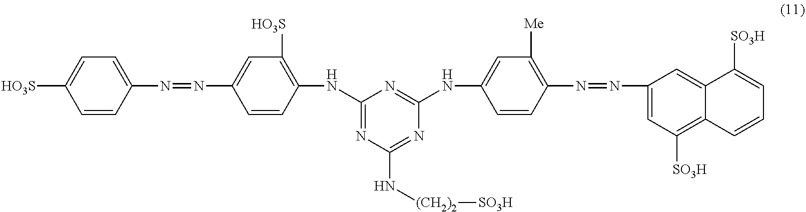

### Example 4

In a similar manner to Example 1 except that 30.3 parts of 2-aminonaphthalene-6,8-disulfonic acid was used in place of 30.3 parts of 2-aminonaphthalene-4,8-disulfonic acid used in the step 1 of Example 1, and that 60.0 parts of 3-aminobenzenesulfonic acid was used in place of 26.3 parts of taurine used in the step 3 of Example 1, 24.5 parts of the water soluble azo compound (Amax: 378 nm) of the present invention represented by the following formula (12) was obtained.

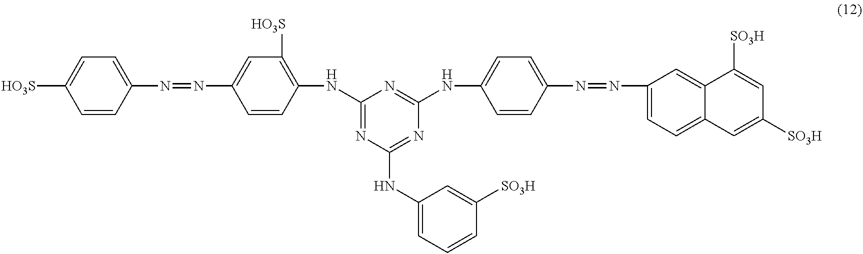

### Examples 5 to 7

### (A) Preparation of Ink

Using the water soluble azo compound of the present invention obtained in the aforementioned Examples 1, 2, and 4 as a coloring matter component, each component was mixed with the composition ratio shown in the following Table 2 to obtain the ink composition of the present invention, which was each filtered through a 0.45 μm membrane filter to remove contaminants, whereby an ink was obtained. It is to be noted that water employed was ion exchanged water, and after adjusting the pH of the ink composition to about 9 with an aqueous sodium hydroxide solution, water was added to give the total volume of 100 parts. Preparations of the inks in which the compounds obtained in Examples 1, 2, and 4 are designated as Examples 5, 6 and 7, respectively.

TABLE 2
Composition Ratio of Ink Composition

| | |
|---|---|
| Azo compound obtained in above each | 3.5 parts |
| Example | |
| glycerin | 9.4 parts |
| urea | 9.4 parts |
| N-methyl-2-pyrrolidone | 7.5 parts |
| isopropyl alcohol | 5.6 parts |
| butylcarbitol | 3.7 parts |
| trade name Surfinol 102PG50 (Note) | 0.2 parts |
| taurine | 0.6 parts |
| sodium ethylenediamine tetraacetate | 0.2 parts |
| sodium hydroxide + water | 59.9 parts |
| Total | 100.0 parts |

(Note) Acetylene glycol based nonionic surfactant, manufactured by Nissin Chemical Co., Ltd.

### Comparative Example 1

Comparative ink was prepared in a similar manner to Examples 5 to 7 except that C. I. Direct Yellow 132 which has been widely used conventionally as a yellow coloring matter for ink jet was used as the coloring matter component in place of the azo compound obtained in each Example. This preparation was designated as Comparative Example 1.

It is to be noted that since C. I. Direct Yellow 132 used in Comparative Example 1 has been available in the market in the form of an aqueous solution, the compound in the dry state was used which had been obtained by drying the aqueous solution using Fine Oven DF42, trade name, manufactured by Yamato Scientific Co., Ltd. at 60° C. for two weeks. This compound was used also in performing Solubility Test (G) described later, and the like.

### Comparative Example 2

Comparative ink was prepared in a similar manner to Examples 5 to 7 except that a sodium salt of a compound represented by the following formula (13) synthesized by the method disclosed in Example 2 of Patent Document 4 was used as the coloring matter component in place of the azo compound obtained in each Example. The structural formula of the Comparative compound used is shown below. This preparation was designated as Comparative Example 2. It is to be noted that the ink prepared in Comparative Example 2 caused gelation, and thus ink jet printing failed according to a common method. Therefore, thus resulting gel was dissolved by heating the obtained gelatinous ink, and ink jet printing was executed while maintaining a solution state. Thus obtained test piece was used in each evaluation test. This ink gelated again when cooled to room temperature.

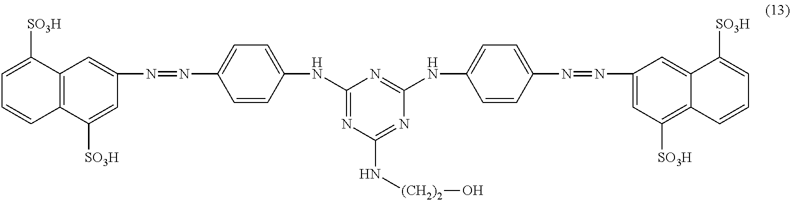

### (B) Ink Jet Printing

Using PIXUS ip4100 (trade name, manufactured by Canon, Inc.) as an ink jet printer, ink jet recording was executed on an ink jet exclusive paper. The ink jet exclusive paper used was Advanced Photo Paper (Glossy) manufactured by Hewlett-Packard Japan, Ltd. Upon the ink jet recording, an image pattern was produced such that several-step gradation of the reflected density was obtained, whereby a yellow printed matter colored with each of the inks of Examples 5 to 7, and Comparative Examples 1 and 2 was obtained.

The moisture resistance test was performed using a printed matter having an unprinted part and a printed part. For the light resistance test and the ozone gas resistance test, reflected density was determined on a part where the reflected density, i.e., D value, of the printed matter before the test was in the range of 0.7 to 1.0. Here, the reflected density was determined using a colorimetric system Sectro Eye, manufactured by Gretag Macbeth Co.

Various test methods and evaluation methods of the test results of the recorded image are described below.

### (C) Color Density of Printed Matter

With respect to a part having the highest reflected density in the image printed on the ink jet exclusive paper, the value of yellow density Dy was measured using the aforementioned colorimetric system. Evaluation criteria are as in the following.

Dy value being no less than 1.70: A

Dy value being less than 1.70 and no less than 1.60: B

Dy value being less than 1.60: C

The results are shown in Table 3.

### (D) Moisture Resistance Test

A test piece produced by printing on the ink jet exclusive paper was left to stand at 30° C. and at 80% RH using a constant temperature and humidity chamber IG400 (manufactured by Yamato Scientific Co., Ltd.) for 7 days, and bleeding of the coloring matter from the printed part to the unprinted part was visually assessed by comparing before and after performing the test. Evaluation criteria are as in the following.

Bleeding of the coloring matter to the unprinted part hardly found: A

Bleeding of the coloring matter to the unprinted part somewhat found: B

Bleeding of the coloring matter to the unprinted part considerably found: C

The results are shown in Table 3.

### (E) Xenon Light Resistance Test

The test piece produced by printing on the ink jet exclusive paper was put into a holder, and irradiated at an illuminance of 0.36 W/m² using a Xenon Weather Meter XL75 (manufactured by Suga Test Instruments Co., Ltd.) at a temperature of 24° C., and a humidity of 60% RH for 168 hrs.

After the testing, the reflected density was determined by colorimetry using the aforementioned colorimetric system, and the residual ratio of the reflected density was determined by calculation according to the formula of: (reflected density after test/reflected density before test) x 100 (%), and evaluation was made by rating on a three point scale.

Residual ratio of the coloring matter being no less than 80%: A

Residual ratio of the coloring matter being no less than 70% and less than 80%: B

Residual ratio of the coloring matter being less than 70%: C

The results are shown in Table 3.

### (F) Ozone Gas Resistance Test

After the test piece produced by printing on the ink jet exclusive paper was left to stand under a condition of: an ozone concentration of 40 ppm; a humidity of 60% RH; and a temperature of 24° C., using an Ozone Weather Meter (manufactured by Suga Test Instruments Co., Ltd.) for 8 hrs, the reflected density was determined by colorimetry using the aforementioned colorimetric system. After the measurement, the residual ratio of the reflected density was determined by calculation according to the formula of: (reflected density after test/reflected density before test)×100 (%), and evaluation was made by rating on a three point scale.

Residual ratio of the coloring matter being no less than 90%: A

Residual ratio of the coloring matter being no less than 70% and less than 90%: B

Residual ratio of the coloring matter being less than 70%: C

The results are shown in Table 3.

### (G) Solubility Test

With respect to each compound used in Examples 5 to 7, and Comparative Examples 1 and 2, solubility in water was tested. As water, ion exchanged water was used, and the test was performed at a pH of about 8, and at a room temperature (25° C.) The solubility was evaluated based on the following criteria.

Water solubility of no less than 100 g/L: A

Water solubility of no less than 50 g/L and less than 100 g/L: B

Water solubility of less than 50 g/L: C

The results are shown in Table 4.

### (H) Storage Stability Test of Ink

With respect to each ink prepared in Examples 5 to 7, and Comparative Examples 1 and 2, storage stability was ascertained by storing in a closed and sealed vessel at room temperatures (18 to 28° C.) for one month. The evaluation was made by visual inspection, and evaluated based on the following criteria.

Neither precipitation nor gelation found after storage for one month: A

Precipitation generated or the ink gelated after storage for one month: C

The results are shown in Table 4.

TABLE 3
Test Results of (C) to (F)

| | (C) | (D) | (E) | (F) |
|---|---|---|---|---|
| Example 5 | A | A | A | A |
| Example 6 | A | A | A | A |
| Example 7 | A | A | A | A |
| Comparative | A | A | A | B |
| Example 1 | | | | |
| Comparative | A | A | A | B |
| Example 2 | | | | |

TABLE 4
Test Results of (G) and (H)

| | (G) | (H) |
|---|---|---|
| Example 5 | A | A |
| Example 6 | A | A |
| Example 7 | A | A |
| Comparative | B | A |
| Example 1 | | |
| Comparative | B | C |
| Example 2 | | |

As is clear from the results shown in Table 3 and Table 4, Comparative Example 1 in which C. I. Direct Yellow 132 was used exhibited superior results in connection with the color density and the moisture resistance test; however, the residual ratio of the reflected density was no less than 70% and less than 80% in the light resistance test (E), and also the residual ratio of the reflected density was no less than 70% and less than 90% in the ozone resistance test (F), revealing that these fastness properties were inferior. Moreover, also in the solubility test (G), the result of no less than 50 g/L and less than 100 g/L was shown, revealing that the solubility was inferior as compared with Examples 5 to 7.

In addition, Comparative Example 2 showed superior results in connection with the color density and the moisture resistance test, and the residual ratio of the reflected density being no less than 80% was also favorable in the light resistance test (E). However, the ozone resistance test (F) showed the residual ratio of the reflected density being no less than 70% and less than 90%, revealing that the ozone resistance was inferior. Furthermore, also in the solubility test (G), the result of no less than 50 g/L and less than 100 g/L was shown, revealing that the water solubility was inferior to Examples 5 to 7. In addition, a phenomenon of gelation was found after a long-term storage stability test of the ink, suggesting that this ink does not withstand practical applications.

In contrast, any of Examples 5 to 7 exhibited superior water solubility of no less than 100 g/L in the solubility test (G), and also exhibited favorable long-term storage stability of the ink. Moreover, Examples 5 to 7 exhibited favorable results also in connection with the color density and the moisture resistance test. Additionally, any of these exhibited the residual ratio of the reflected density of no less than 80% in the light resistance test (E), revealing that they are superior in light resistance. Moreover, also in the ozone resistance test (F), the residual ratio of the reflected density of no less than 90% was exhibited, revealing that they are superior in these fastness properties as compared with conventional products.

From the foregoing results, it is concluded that Examples 5 to 7 exhibited superior light resistance and ozone resistance as compared with Comparative Example 1, and exhibited superior ozone resistance as compared with Comparative Example 2, without causing gelation when prepared into an ink, thereby suggesting that they have favorable storage stability.

### Example 8

In a similar manner to Example 1 except that 27.6 parts of 6-aminohexanoic acid was used in place of 26.3 parts of taurine used in step 3 of Example 1, 49.0 parts of the water soluble azo compound (Amax: 378 nm) of the present invention represented by the following formula (14) was obtained.

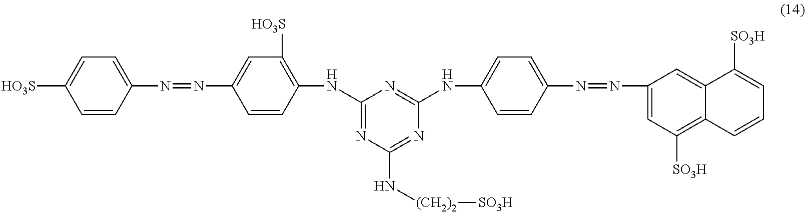

### Example 9

Similarly to Examples 5 to 7 except that the compound obtained in Example 8 was used in place of the compound obtained in Example 1, 2, or 4, an ink was prepared according to the method of the above “(A) Preparation of Ink”. The preparation of this ink is designated as Example 9.

### Comparative Example 3

Comparative ink was prepared similarly to Examples 5 to 7 except that a sodium salt of Dye1 represented by the following formula (15) disclosed in Example 1 of Patent Document 5 was used as the coloring matter component in place of the azo compound obtained in each Example. The structural formula of the comparative compound used is shown below. This preparation was designated as Comparative Example 3.

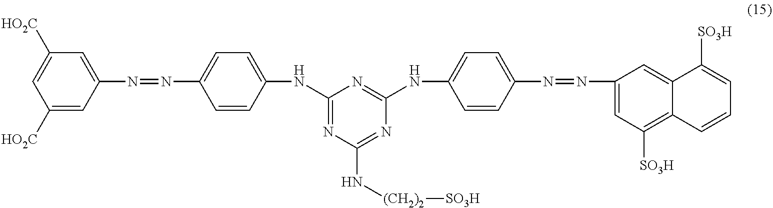

### (I) Ink Jet Printing (2)

Similarly to “(B) Ink Jet Printing” described above, yellow printed matters colored with the inks of Example 9, and Comparative Examples 1 and 3, respectively were obtained. It is to be noted that since the ink prepared in Comparative Example 2 gelated as described above, the printed matter was not produced.

With respect to each printed matter thus obtained, various tests and evaluations of the recorded image were carried out similarly to each of the evaluation tests described above that correspond to the following (J) to (L) except that the test conditions and evaluations (criteria) were as in the following (J) to (L).

### (J) Moisture Resistance Test (2)

The test piece produced by printing on the ink jet exclusive paper was left to stand at 30° C. and at 80% RH using a constant temperature and humidity chamber IG400 (manufactured by Yamato Scientific Co., Ltd.) for 6 days, and bleeding of the coloring matter from the printed part to the unprinted part was visually assessed by comparing before and after performing the test. Evaluation criteria are as in the following.

Bleeding of the coloring matter to the unprinted part hardly found: A

Bleeding of the coloring matter to the unprinted part somewhat found: B

Bleeding of the coloring matter to the unprinted part considerably found: C

The results are shown in Table 5.

### (K) Xenon Light Resistance Test (2)

The test piece produced by printing on the ink jet exclusive paper was put into a holder, and irradiated at an illuminance of 0.36 W/m² using a Xenon Weather Meter XL75 (manufactured by Suga Test Instruments Co., Ltd.) at a temperature of 24° C., and a humidity of 60% RH for 120 hrs.

After the testing, the reflected density was determined by colorimetry using the aforementioned colorimetric system, and the residual ratio of the reflected density was determined by calculation according to the formula of: (reflected density after test/reflected density before test)×100 (%), and evaluation was made by rating on a three point scale.

Residual ratio of the coloring matter being no less than 90%: A

Residual ratio of the coloring matter being no less than 80% and less than 90%: B

Residual ratio of the coloring matter being less than 80%: C

The results are shown in Table 5.

### (L) Ozone Gas Resistance Test (2)

After the test piece produced by printing on the ink jet exclusive paper was left to stand under a condition of: an ozone concentration of 40 ppm; a humidity of 60% RH; and a temperature of 24° C., using Ozone Weather Meter (manufactured by Suga Test Instruments Co., Ltd.) for 16 hrs, the reflected density was determined by colorimetry using the aforementioned colorimetric system. After the measurement, the residual ratio of the reflected density was determined by calculation according to the formula of: (reflected density after test/reflected density before test)×100 (%), and evaluation was made by rating on a three point scale.

Residual ratio of the coloring matter being no less than 85%: A

Residual ratio of the coloring matter being no less than 80% and less than 85%: B

Residual ratio of the coloring matter being less than 80%: C

The results are shown in Table 5.

TABLE 5
Test Results of (J) to (L)

| | (J) | (K) | (L) |
|---|---|---|---|
| Example 9 | A | A | A |
| Comparative | B | C | C |
| Example 1 | | | |
| Comparative | A | B | C |
| Example 3 | | | |

As is clear from the results shown in Table 5, it was ascertained that Example 9 is extremely superior to each Comparative Example both in terms of xenon light resistance and ozone gas resistance.

Accordingly, the water soluble azo compound of the present invention is suited for preparing an ink composition for ink jet recording, and is extremely superior in various fastness properties, particularly light resistance and ozone gas resistance. In addition, the water soluble azo compound of the present invention has high water solubility, and has favorable storage stability without causing either precipitation or gelation, even if stored for a long period of time. Moreover, the azo compound of the present invention has a high color density, as well as a favorable and brilliant hue. From these features, it is clear that the azo compound of the present invention is a compound which is very useful as a variety of ink coloring matters for recording, particularly as yellow coloring matters for ink jet inks.

1. A water soluble azo compound represented by the following formula (1) or a salt thereof, 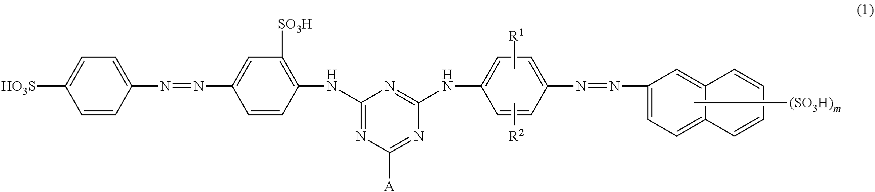
wherein,
R¹ and R² each independently represent a hydrogen atom, an alkyl group having 1 to 4 carbon atoms, or an alkoxy group having 1 to 4 carbon atoms;
m represents an integer of 1 to 3; and
the group A represents an amine residue represented by any one of the following formulae (2) to (5). 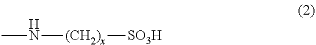
wherein, x represents an integer of 1 to 3. 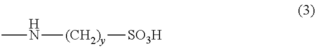
wherein, y represents an integer of 1 to 11.

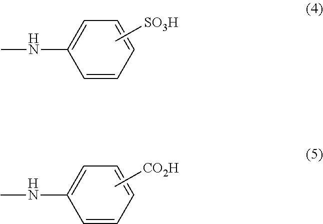

2. The water soluble azo compound or a salt thereof according to claim 1, wherein: R¹ and R² in the formula (1) are both a hydrogen atom; and m is 2.

3. The water soluble azo compound or a salt thereof according to claim 2, wherein the group A in the formula (1) is represented by the formula (2) or (3).

4. The water soluble azo compound or a salt thereof according to claim 2, wherein the group A in the formula (1) is represented by the formula (4).

5. An ink composition comprising the water soluble azo compound or a salt thereof according to claim 1.

6. The ink composition according to claim 5 further comprising a water soluble organic solvent.

7. The ink composition according to claim 5, wherein said ink composition is used in ink jet recording.

8. An ink jet recording method comprising discharging ink droplets in response to recording signals using the ink composition according to claim 5 as an ink to execute recording on a record-receiving material.

9. The ink jet recording method according to claim 8, wherein the record-receiving material is a sheet for distributing information.

10. The ink jet recording method according to claim 9, wherein the sheet for distributing information is a sheet having an ink receiving layer containing a porous white inorganic substance.

11. A colored body was colored with the water soluble azo compound or a salt thereof according to claim 1.

12. The colored body according to claim 11, wherein the coloring is carried out with an ink jet printer.

13. An ink jet printer equipped with a vessel containing the ink composition according to claim 5.

14. A colored body colored with the ink composition according to claim 5.
